(19) United States
(12) Patent Application Publication
(10) Pub. No.: US 2025/0101341 A1
(43) Pub. Date: Mar. 27, 2025

(54) DETERGENT COMPOSITION

(71) Applicant: Conopco, Inc., d/b/a UNILEVER, Englewood Cliffs, NJ (US)

(72) Inventors: David Stephen GRAINGER, Chester (GB); Nicholas James WESTWOOD, Dundee (GB); Timur Arthur MCARDLE-ISMAGUILOV, St Andrews Fife (GB)

(73) Assignee: Conopco, Inc., d/b/a UNILEVER, Englewood Cliffs, NJ (US)

(21) Appl. No.: 18/692,122

(22) PCT Filed: Sep. 16, 2022
(86) PCT No.: PCT/EP2022/075748

§ 371 Date: Mar. 14, 2024

(30) Foreign Application Priority Data
Sep. 20, 2021 (EP) 21197764.0

(51) Int. Cl. C11D 1/83; C11D 1/30; C11D 1/72; C11D 3/00; C11D 3/37; C11D 3/386

(52) U.S. Cl. CPC C11D 1/83; C11D 3/0036; C11D 3/3715; C11D 3/386; C11D 1/30; C11D 1/72

(57) ABSTRACT

The invention concerns a detergent composition, comprising: (a) from 0.5 to 40 wt. % of alignin derived anionic surfactant, wherein the lignin derived anionic surfactant has the following structure (1) or (2), preferably (1): Formula (1) or, Formula (2) wherein: M is a counterion; R¹ and R² are alkyl or alkenyl groups, each either linear or branched; the alkyl or alkyenyl groups R¹ and R² added together contain from 5 to 15 carbon atoms; with the proviso that R¹ and R² each contain at least 1 carbon atom; the invention also concerns a method, preferably a domestic method of treating a textile.

### FIELD OF INVENTION

The present invention concerns a detergent composition. More particularly a detergent composition comprising a lignin derived anionic surfactant.

### BACKGROUND OF THE INVENTION

Surfactants comprise an oil soluble hydrocarbon chain with a water solubilising group attached to it. Detergent compositions comprise surfactants to remove soils from substrates. For example, laundry detergents contain surfactants to remove soils from clothing during washing. Many typical detergents contain a mix of anionic and non-ionic surfactants with predominately C12 hydrocarbon chains.

There is a wish to produce anionic surfactants from greener materials.

There is however a need to improve detergent compositions containing more environmentally friendly surfactants. A problem that exists is to produce surfactants from waste or green material that are comparable to existing surfactants Surprisingly, this problem can be solved by the inclusion of a lignin based anionic surfactant having the structure as disclosed herein.

### SUMMARY OF THE INVENTION

The invention relates to a detergent composition comprising:
a) from 0.5 to 40 wt. %, preferably from 1 to 30 wt. %, more preferably from 1 to 25 wt. %, most preferably from 1 to 20 wt. % of a lignin derived anionic surfactant
wherein the lignin derived anionic surfactant has the following structure (1) or (2), preferably (1):

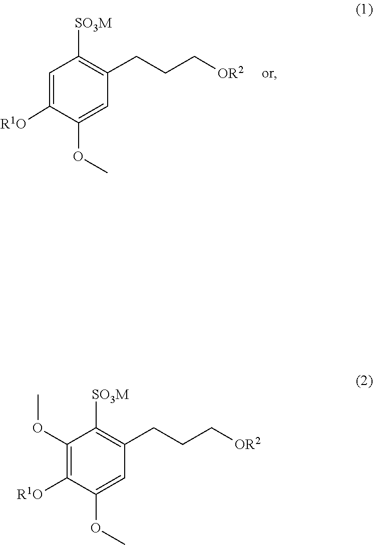

wherein: M is a counterion, preferably selected from Na, K, NH₄, most preferably Na; R¹ and R² are alkyl or alkenyl groups, preferably alkyl, each either linear or branched, preferably linear;
   the alkyl or alkyenyl groups R¹ and R² added together contain from 5 to 15 carbon atoms, preferably from 7 to 15 carbon atoms;
   with the proviso that R¹ and R² each contain at least 1 carbon atom Preferably the alkyl or alkenyl groups R¹ and R² are linear. Preferably they are both linear, more preferably they are both linear alkyl.

Preferably R¹ has from 5 to 14 carbon atoms, preferably from 5 to 12 carbon atoms, more preferably from 8 to 12 carbon atoms.

Preferably R² has from 1 to 8 carbon atoms, preferably from 1 to 7 carbon atoms, more preferably from 1 to 5 carbon atoms.

Preferably R¹ has from 8 to 12 carbon atoms, and R² has from 1 to 5 carbon atoms.

Preferably the alkyl groups R¹ and R² added together contain from 9 to 15 carbon atoms, preferably from 11 to 15 carbon atoms.

Preferably the composition may additionally comprise from 1 to 40 wt. %, preferably from 2 to 30 wt. %, most preferably from 2 to 25 wt. %, most preferably from 2 to 20 wt. % of one or more nonionic surfactants, wherein the nonionic surfactant is selected from alcohol alkoxylates (preferably alcohol ethoxylates), alkyl polyglucosides, alkyl polypentosides, and nonionic biosurfactants. Most preferred nonionic surfactants are preferably selected from alcohol ethoxylates having from C12-C15 with a mole average of from 5 to 9 ethoxylates and/or alcohol ethoxylates having from C16-C18 with a mole average of from 7 to 14 ethoxylates.

Preferably the composition may additionally comprise from 1 to 40 wt. %, preferably from 2 to 30 wt. %, most preferably from 2 to 25 wt. %, most preferably from 2 to 20 wt. % of one or more additional anionic surfactants, (other than (a), the lignin based anionic surfactant); the additional anionic surfactant is preferably selected from primary alkyl sulfates, secondary alkane sulfonates, linear alkyl benzene sulfonates, alkyl ether sulfates, internal olefin sulfonates, alpha olefin sulfonates, soaps, anionically modified APGs, furan based anionics, anionic biosurfactants (e.g. rhamnolipids), and, citrems, tatems and datems, more preferably selected from primary alkyl sulfates, secondary alkane sulfonates, linear alkyl benzene sulfonates, alkyl ether sulfates, furan based anionics, and rhamnolipids.

Preferably the composition comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers, soil release polymers, alkoxylated polycarboxylic acid esters and mixtures thereof.

Preferably the antiredeposition polymers are alkoxylated polyamines; and/or the soil release polymer is a polyester soil release polymer.

Preferably the detergent composition is a laundry detergent composition, more preferably a laundry liquid detergent composition, or a liquid unit dose detergent composition.

Preferably the composition comprises one or more enzymes from the group: lipases proteases, alpha-amylases, cellulases, peroxidases/oxidases, pectate lyases, and mannanases, or mixtures thereof, more preferably lipases, proteases, alpha-amylases, cellulases and mixtures thereof, wherein the level of each enzyme in the composition of the invention is from 0.0001 wt. % to 0.1 wt. %.

In a second aspect the invention provides a method, preferably a domestic method, of treating a textile, the method comprising the step of: treating a textile with an aqueous solution of 0.5 to 20 g/L of the detergent composition, preferably the laundry liquid detergent composition, of the first aspect.

Preferably in the method the aqueous solution contains 0.1 to 1.0 g/L of the surfactants of (a) and (b).

The method, preferably a domestic method taking place in the home using domestic appliances, preferably occurs at wash water temperatures of 280 to 335K. The textile is preferable soiled with sebum arising from contact with human skin.

### DETAILED DESCRIPTION OF THE INVENTION

The indefinite article “a” or “an” and its corresponding definite article “the” as used herein means at least one, or one or more, unless specified otherwise.

All enzyme levels refer to pure protein.

wt. % relates to the amount by weight of the ingredient based on the total weight of the composition. For charged surfactants (for example anionic surfactants), wt. % is calculated based on the protonated form of the surfactant.

The detergent composition may be in any form, for example a liquid, solid, powder, liquid unit dose. The detergent composition is particularly suitable for use in the domestic environment, for example home hygiene compositions, hand dishwash compositions or laundry compositions. Preferably the composition is a liquid detergent composition or a liquid unit dose detergent composition. More preferably the detergent composition is a laundry detergent composition, more preferably a laundry liquid detergent composition, or a liquid unit dose detergent composition.

The formulation when dissolved in demineralised water at 20° C. preferably has a pH of 3 to 10, more preferably from 4 to 9, more preferably 5 to 7.5, most preferably 7.

The integers ‘q’ are mole average values.

### Lignin Derived Surfactant

The detergent composition comprises from 0.5 to 40 wt. %, preferably from 1 to 30 wt. %, more preferably from 1 to 25 wt. %, most preferably from 1 to 20 wt. % of a lignin derived anionic surfactant.

The lignin based anionic surfactant has the following structure (1) or (2), preferably (1):

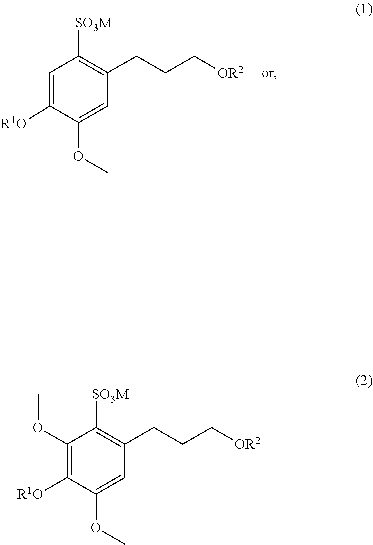

wherein: M is a counterion, preferably selected from Na, K, NH₄, most preferably Na; R¹ and R² are alkyl or alkenyl groups, preferably alkyl, each either linear or branched, preferably linear;
   the alkyl or alkyenyl groups, preferably alkyl, R¹ and R² added together contain from 5 to 15 carbon atoms, preferably from 7 to 15 carbon atoms;
   with the proviso that R¹ and R² each contain at least 1 carbon atom

While the lignin derived anionic surfactant may have the following structure (1) or (2),

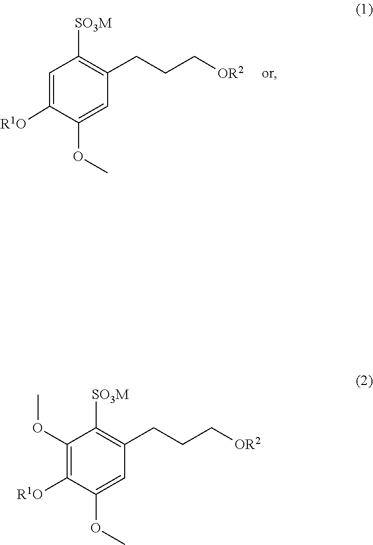

it is preferred if the lignin derived anionic surfactant has the structure (1) as described above:-

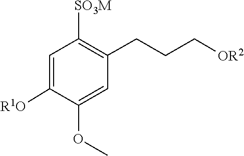

The lignin derived anionic surfactant has alkyl groups on both sides of the benzene ring. The stipulation that the alkyl groups R¹ and R² added together contain from 5 to 15 carbon atoms means that along with the three atoms linking the OR² group the benzene ring, the surfactant can be considered as a C₈ to C18 surfactant, preferably a C10 to C18 surfactant, more preferably a C₁₂ to C18 surfactant.

Preferably the alkyl or alkenyl groups R¹ and R² are linear.

Preferably R¹ has from 5 to 14 carbon atoms, preferably from 5 to 12 carbon atoms, more preferably from 8 to 12 carbon atoms.

Preferably R² has from 1 to 8 carbon atoms, preferably from 1 to 7 carbon atoms, more preferably from 1 to 5 carbon atoms.

Preferably R¹ has from 8 to 12 carbon atoms, and R² has from 1 to 5 carbon atoms.

Preferably the alkyl groups R¹ and R² added together contain from 9 to 15 carbon atoms, preferably from 11 to 15 carbon atoms, more preferably from 11 to 13 carbon atoms, most preferably 13 carbon atoms.

### Method of Manufacture of the Lignin Derived Anionic Surfactants

The lignin derived surfactants of this invention can be prepared as follows.

The first step is to isolate lignin from the lignocellulosic biomass with minimal chemical modification to the lignin biopolymer. This typically requires the use of a lignin-first biorefining process that avoids the formation of undesirable condensation products and also avoids the highly derivatised polymers such as lignosulphonates that are typical with processes used for paper and pulp processing.

Lignin depolymerisation is a complex process with many possible variables. Preferred routes to obtaining lignin polymers that are suitable for further derivatisation according to this invention are those based on solvent methods which preserve the lignin structure. These are described in detail in “Guidelines for performing Lignin First Biorefining” (Abu-Omar et al, Energy and Environmental Science, 2021, vol 14, 262-292). The most preferred extraction route is the dioxasolv process which involves treating lignocellulosic biomass (for example sawdust from Birch) with a mildly acid solution of dioxane. Other biobased solvents such as ethanol and butanol are also suitable.

Next the lignin polymer needs to be selectively depolymerised to maximise the yield of the required monoaromatic species from which the surfactant can then be generated. This was conducted using the process described in “Isolation of Functionalised Phenolic Monomers through selective Oxidation and C-O Bond Cleavage of the β-O-4 Linkages in Lignin” (Lancefield et al, Angew. Chem. Int. Ed., 2015, vol 54, 258-262).

Oxidation of the lignin was then performed using the DDQ catalysed (2, 3-dichloro-5, 6-dicyano-1, 4-benzoquinone) conditions described in Lancefield et al. This was followed by selective degradation of the oxidised β-O-4 structure using a Zinc reductant to give the following monomer structure:-

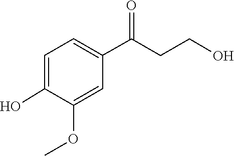

It was also possible to isolate the following monomer structure, which can be used in the same way to make lignin derived anionic surfactants of chemical formula (2).

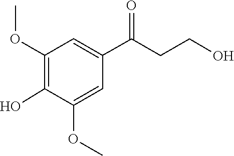 [SMILES: COc1cc(C(=O)CCO)cc(OC)c1O]

For those skilled in the art, it will be appreciated that other routes to this monomer from lignin/lignocelluloses are also possible such as those reported by Stephenson et al. in which they demonstrated that the required monomer could be obtained in a 1.3 wt. % yield under ambient conditions. Details of which are given in the following two papers.
Bosque, Irene; Magallanes, Gabriel; Rigoulet, Mathilde; Karkas, Markus D.; Stephenson, Corey R. J. ACS Central Science (2017), 3(6), 621-628.
Magallanes, Gabriel; Karkas, Markus D.; Bosque, Irene; Lee, Sudarat; Maldonado, Stephen; Stephenson, Corey R. J. ACS Catalysis (2019), 9(3), 2252-2260.

Biocatalytic approaches to the required monomer have also been reported including the development of a one-pot, three-step enzymatic cascade process using lignin from eucalyptus reported by that of Ohta et al.

Ohta, Yukari; Hasegawa, Ryoichi; Kurosawa, Kanako; Maeda, Allyn H.; Koizumi, Toshio; Nishimura, Hiroshi; Okada, Hitomi; Qu, Chen; Saito, Kaori; Watanabe, Takashi; et al, ChemSusChem (2017), 10(2), 425-433.

Using this lignin derived aromatic monomer as a starting point, the following reaction scheme highlights the synthetic pathway for a lignin based anionic surfactant whereby R¹=C₁₂ Lauryl. Understanding that the reactants can be substituted by alternatives such that R¹ and R² can vary in length, degree of saturation and degree of branching.

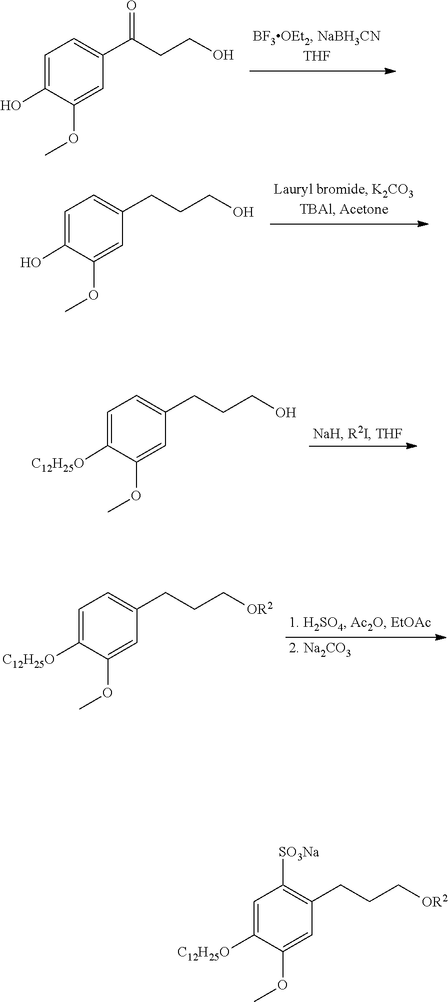

Conversion of the ketone group in the monomer to a methylene group is achieved using a reduction involving a Lewis acid and a reducing agent (in the preferred example the Lewis acid is BF₃·OEt₂ and a hydride reducing agent is used but a wide range of different Lewis acids and reducing agents are known to work for this type of reaction e.g. ZnI₂ combined with Et₃SiH). Alternative methods for carrying out this reaction include the use of H₂ in the presence of a metal catalyst e.g. Pd/C or Ni or the use of the Wolff-Kishner reaction.

Then the R¹ group (in this example Lauryl) is attached via alkylation of the phenolic OH using a suitable alkyl halide in the presence of a base. In this case the alkylating agent is lauryl iodide which is generated in situ from the bromide on reaction with TBAI. A wide range of alternative inorganic bases could be used in this reaction including Na₂CO₃, NaH, LiHMDS, NaHMDS etc. Alternative approaches to derivatisation of the phenolic oxygen include the use of the Mitsonobu reaction. After selective incorporation of the R¹ substituent, the R² group can then be added through alkylation of the primary alcohol. Again, the required alkyl halide and a base (eg NaH) are used. The incorporation of the sulfonate group can be achieved using H₂SO₄ in the presence of an anhydride (for example acetic anhydride). Alternative sulfonation protocols would be expected to achieve an analogous reaction outcome. The initially produced sulfonic acid is then converted to the required sulfonate salt using an inorganic base (for example the use of Na₂CO₃ to generate the sodium sulfonate).

Exemplar lignin derived anionic surfactant materials that can be made include the following according to chemical formula (1)

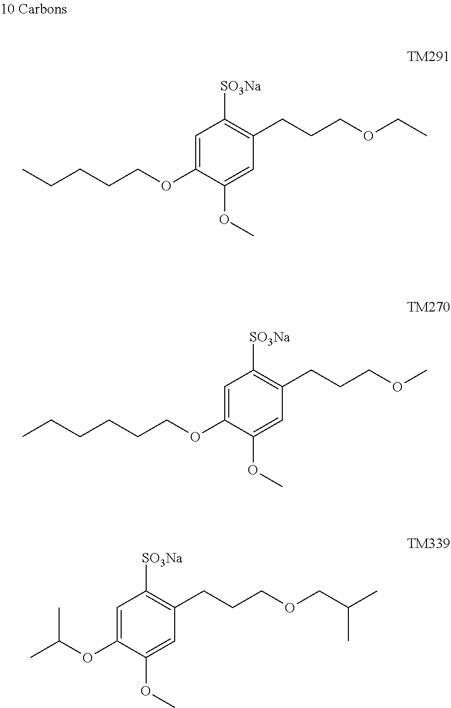

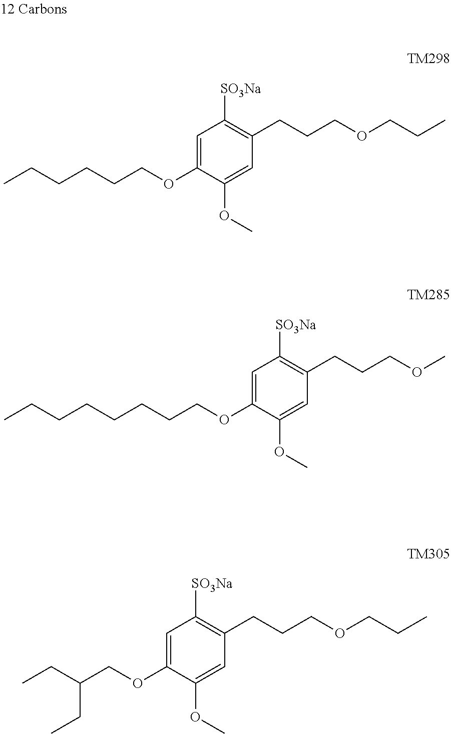

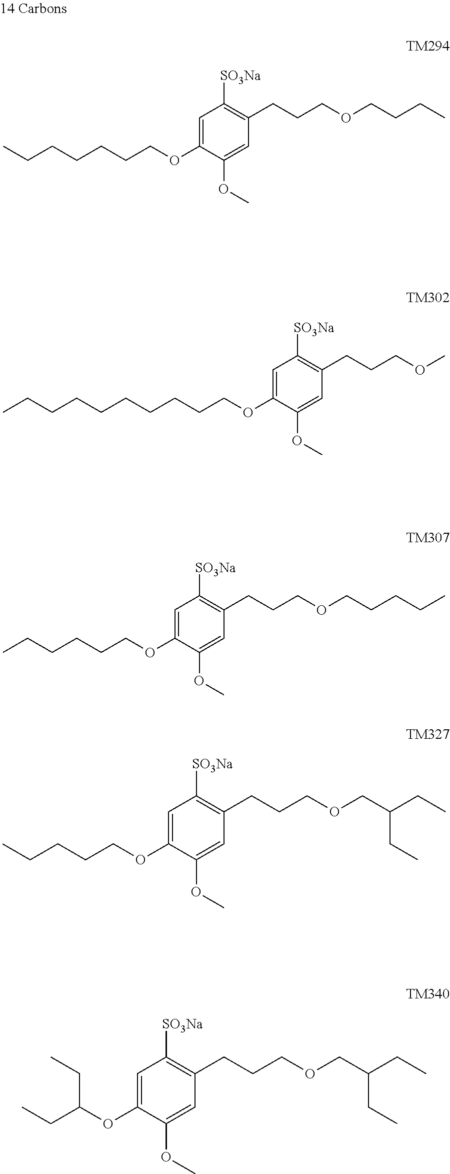

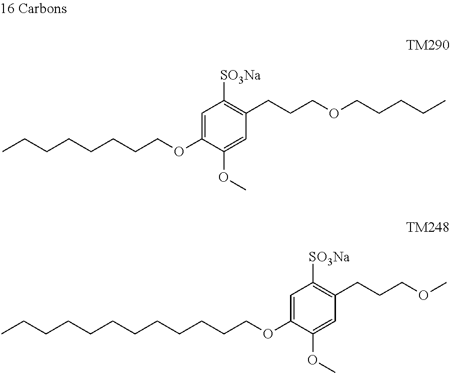

Exemplar lignin derived anionic surfactant materials that can be made include the following according to chemical formula (2)

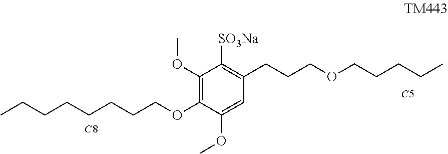

### Further Preferred Ingredients

### Additional Surfactants

The composition may comprise additional surfactant other than the lignin derived anionic surfactant.

Additional surfactants may include additional anionic surfactants, nonionic surfactants and amphoteric surfactants.

### Preferred Source of Alkyl Chains Used in the Surfactants

With the exception of biosurfactants, many commercial surfactants are derived from fatty alcohol precursors. Accordingly, forming the linear alcohol is a central step in obtaining many commercial surfactants.

The linear alcohols which are suitable as an intermediate step in the manufacture of surfactants such as APGs and alcohol ethoxylates can be obtained from many different sustainable sources. These include:

### Primary Sugars

Primary sugars are obtained from cane sugar or sugar beet, etc., and may be fermented to from bioethanol. The bioethanol is then dehydrated to form bio-ethylene which then can then be converted to olefins by processes such as the Shell Higher Olefin Process or the Chevron Phillips Full Range process. These alkenes can then be processed into linear alcohols by hydroformylation followed by hydrogenation.

Alternatively, the ethylene can be converted directly to the fatty alcohol via the Ziegler process.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

### Biomass

Biomass, for example forestry products, rice husks and straw to name a few may be processed into syngas [Synthesis Gas] by gasification. Through a Fischer Tropsch reaction these are processed into alkanes, which in turn are dehydrogenated to form olefins. These olefins may be processed in the same manner as the alkenes described above [primary sugars].

An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

### Waste Plastics

Waste plastic is pyrolyzed to form pyrolysis oil. This is then fractioned to form linear alkanes which are dehydrogenated to form alkenes. These alkenes are processed as described above [primary sugars].

Alternatively, the pyrolyzed oils are cracked to form ethylene which is then processed to form the required alkenes by the same processes described above in [primary sugars]. The alkenes are then processed into linear alcohols as described above [primary sugars].

### MSW (Municipal Solid Waste)

MSW is turned into syngas by gasification. From syngas it may be processed to alkanes as described above [Biomass] or it may be converted into ethanol by enzymatic processes (e.g. Lanzatech process) before being dehydrogenated into ethylene. The ethylene may then be turned into linear alcohols by the processes described above [primary sugars].

Syngas can also be converted to methanol and then on to ethylene. At which point the processes described in [primary sugars] convert it to the final fatty alcohol.

The MSW may also be turned into pyrolysis oil by gasification and then fractioned to form alkanes. These alkanes are then dehydrogenated to form olefins and then linear alcohols.

Equally, the organic fraction of MSW contains polysaccharides which can be broken down enzymatically into sugars. At which point they can be fermented to ethanol, dehydrated to ethylene and converted to the fatty alcohol via routes described above.

### Marine Carbon

There are various carbon sources from marine flora such as seaweed and kelp. From such marine flora the triglycerides can be separated from the source and which is then hydrolysed to form the fatty acids which are reduced to linear alcohols in the usual manner.

Alternatively, the raw material can be separated into polysaccharides which are enzymatically degraded to form secondary sugars. These may be fermented to form bioethanol and then processed as described above [Primary Sugars].

### Waste Oils

Waste oils such as used cooking oil can be physically separated into the triglycerides which are split to form linear fatty acids and then linear alcohols as described above.

Alternatively, the used cooking oil may be subjected to the Neste Process whereby the oil is catalytically cracked to form bio-ethylene. This is then processed as described above [primary sugars].

### Nonionic Surfactant

The composition may additionally and preferably comprise from 1 to 40 wt. %, preferably from 2 to 30 wt. %, most preferably from 2 to 25 wt. %, most preferably from 2 to 20 wt. % of one or more nonionic surfactants.

The nonionic surfactant can be chosen from any typical detergent type nonionic surfactant. Preferred nonionic surfactants include alcohol alkoxylates (preferably ethoxylates), alkyl polyglucosides, alkyl polypentosides, and nonionic biosurfactants.

Where the nonionic is an alcohol ethoxylate it preferably has the formula:

R₁—(OCH₂CH₂)_{q}OH
where R₁ is preferably selected from saturated or monounsaturated linear C10 to C18 alkyl chains and where q is from 4 to 20, preferably 5 to 12, more preferably 5 to 14.

Alcohol ethoxylates are discussed in the Nonionic Surfactants: Organic Chemistry edited by Nico M. van Os (Marcel Dekker 1998), Surfactant Science Series published by CRC press.

Alcohol ethoxylates may be synthesised by ethoxylation of an alkyl alcohol, via the reaction:

R₁—OH+q ethylene oxide→R₁—O—(CH₂CH₂O)_{q}—H

It is preferred that R derives from natural or biosynthetic feedstocks (for example vegetable or algal oils). The alkyl alcohol may be produced by transesterification of the triglyceride to a methyl ester, followed by distillation and hydrogenation.

Such ethoxylation reactions are described in Non-Ionic Surfactant Organic Chemistry (N. M. van Os ed), Surfactant Science Series Volume 72, CRC Press.

Preferably the reactions are base catalysed using NaOH, KOH, or NaOCH₃. Even more preferred are catalyst which provide narrower ethoxy distribution than NaOH, KOH, or NaOCH₃. Preferably these narrower distribution catalysts involve a Group II base such as Ba dodecanoate; Group II metal alkoxides; Group II hyrodrotalcite as described in WO2007/147866. Lanthanides may also be used. Such narrower distribution alcohol ethoxylates are available from Azo Nobel and Sasol.

Preferably the ethoxy distribution has greater than 70 wt. %, more preferably greater than 80 wt. % of the alcohol ethoxylate R—O—(CH₂CH₂O)q—H in the range R—O—(CH₂CH₂O)ₓ—H to R—O—(CH₂CH₂O)_{y}—H where q is the mole average degree of ethoxylation and x and y are absolute numbers, where x=q−q/2 and y=q+q/2.

For example when q=10, then the greater than 70 wt. % of the alcohol ethoxylate should consist of ethoxylate with 5, 6, 7, 8, 9 10, 11, 12, 13, 14 and 15 ethoxylate groups.

Preferred nonionic surfactants are preferably selected from alcohol ethoxylates having from C12-C15 with a mole average of from 5 to 9 ethoxylates and/or alcohol ethoxylates having from C16-C18 with a mole average of from 7 to 14 ethoxylates.

The alkyl polyglucoside (APG) can be any typical nonionic detergent APG as described in alkyl polyglucosides (APGs) Surfactants and Their Properties: A Review (Tenside Surfactants Detergents September 2012, Vol. 49, No. 5, pages 417-427). It is preferred that the APGs have a DP (degree of polymerisation) of between 1 and 2, most preferably between 1.2 and 1.8. The alkyl chain is preferably between C10-C16 in length.

The alkyl polypentoside (APP) can be any typical nonionic detergent APP especially where the C5 sugar is xylose which is readily available from multiple biomass sources. The alkyl chain is preferably between C10-C16 in length. For example, preferred materials are APPs under the APPYCLEAN tradename from Wheatoleo.

### Additional Anionic Surfactant

Preferably, the composition may additionally comprise from 1 to 40 wt. %, preferably from 2 to 30 wt. %, most preferably from 2 to 25 wt. %, most preferably from 2 to 20 wt. % of one or more additional anionic surfactants (other than (a), the lignin based anionic surfactant).

The additional anionic surfactant is preferably selected from primary alkyl sulfates, secondary alkane sulfonates, linear alkyl benzene sulfonates, alkyl ether sulfates, internal olefin sulfonates, alpha olefin sulfonates, soaps, anionically modified APGs, furan based anionics, anionic biosurfactants (preferably rhamnolipids), and, citrems, tatems and datems, more preferably selected from primary alkyl sulfates, secondary alkane sulfonates, linear alkyl benzene sulfonates, alkyl ether sulfates, furan based anionics, and rhamnolipids.

Additional preferred anionic surfactants include primary alkyl sulfates, preferably a C₁₀-C₂₀ alkyl sulfate, preferably a lauryl sulfate. The primary alkyl sulfate preferably is in the form with a counterion, more preferably the counterion is a sodium, potassium or ammonium ion. Examples of preferred materials include sodium C₁₀-C₂₀ alkyl sulfate, most preferably sodium lauryl sulfate.

Additional preferred anionic surfactants include secondary alkane sulfonates, preferably C₁₄-C₁₈, for example C₁₅-C₁₈ or even C₁₅-C₁₇ secondary alkane sulfonates.

Additional preferred anionic surfactants include linear alkylbenzene sulfonates. Linear alkyl benzene sulfonate is the neutralised form of linear alkyl benzene sulfonic acid. Neutralisation may be carried out with any suitable base.

Linear alkyl benzene sulfonic acid has the structure:

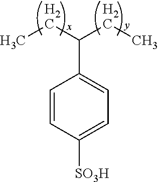

where x+y=7, 8, 9 or 10. Preferably x+y=8 is present at greater than 28 wt. % of the total LAS. Preferably x+y=9 is present at greater than 28 wt. % of the total LAS. Weights are expressed as the protonated form. It may be produced by a variety of different routes. Synthesis is discussed in Anionic Surfactants Organic Chemistry edited by H. W. Stache (Marcel Dekker, New York 1996). Linear alkyl benzene sulfonic acid may be made by the sulfonation of Linear alkyl benzene. The sulfation can be carried out with concentrated sulphuric acid, oleum or sulphur trioxide. Linear alkyl benzene sulfonic acid produced by reaction of linear alkyl benzene with sulphur trioxide is preferred.

Linear alkyl benzene may be produced by a variety of routes. Benzene may be alkylated with n-alkenes using HF catalyst. Benzene may be alkylated with n-alkenes in a fixed bed reactor with a solid acidic catalyst such as alumosilicate (DETAL process). Benzene may be alkylated with n-alkenes using an aluminium chloride catalyst. Benzene may be alkylated with n-chloroparaffins using an aluminium chloride catalyst.

Additional preferred anionic surfactants include the alkyl ether sulfate surfactants of formula:

RO(CH₂CH₂O)_{q}SO₃M
wherein R is an saturated or monunsaturated C₁₀-C₁₈ linear alkyl chain, q is a mole average ethoxylation of from 0.5 to 16, and M is a cation which can be, for example, a metal cation (e.g., sodium, potassium, lithium, calcium, magnesium, etc.), ammonium or substituted-ammonium cation.

Preferred alkyl ether sulfate surfactants include where R is a C₁₂-C₁₅ alkyl chain, most preferably lauryl; and where q in the above formula is from 0.5 to 3, most preferably from 2.5 to 3.5.

Other preferred alkyl ether sulfate surfactants include where R is a C₁₆-C₁₈ alkyl chain, most preferably a monounsaturated C₁₆-C₁₈ alkyl chain; and where q in the above formula is from 5 to 15, most preferably from 6 to 12.

Additional preferred anionic surfactants include internal olefin sulfonates. An internal olefin sulfonate molecule is an alkene or hydroxyalkane which contains one or more sulfonate groups. Such materials are discussed in EP 3 162 872 A1.

Additional preferred anionic surfactants include alpha olefin sulfonates. Alpha olefin suflonate is a mixture of long chain sulfonate salts prepared by the sulfonation of alpha olefins. Preferred alpha olefin sulfonates include sodium C12-C18 alpha olefin sulfonates.

Additional preferred anionic surfactants include soaps. Preferred soaps include C10-C20, preferably C12-C18 fatty acids neutralised with a suitable counterion, for example, sodium, potassium or ammonium, preferably sodium.

Additional preferred anionic surfactants include anionically modified alkyl polyglucosides (APGs) (for example Suganate ex Colonial Chemical).

Additional preferred anionic surfactants include anionic furan type surfactants, such as those disclosed in PCT/EP2020/061701 (unpublished at time of filing), WO15/84813, WO17/79718 and WO17/79719.

Additional preferred anionic surfactants include any biosurfactant that has anionic character, for example sophorolipids, trehalolipid and rhamnolipids. Preferable are the mono-rhamnolipids and di-rhamnolipids. The preferred alkyl chain length is from C₈ to C₁₂. The alkyl chain may be saturated or unsaturated. Preferably the rhamnolipid is a di-rhamnolipid of formula: Rha2C₈₋₁₂C₈₋₁₂.

Additional preferred anionic surfactants include citrem, tatem, and datem. These are described in WO2020/058088 (Unilever), Hasenhuettl, G. L and Hartel, R. W. (Eds) Food Emulsifiers and Their Application 2008 (Springer) and in Whitehurst, R. J. (Ed) Emulsifiers in Food Technology 2008 (Wiley-VCH). Monoglyceride based Datems with 1 to 2 diacetyl tartaric acid units per mole surfactant are most preferred.

More preferably, the additional preferred anionic surfactants are selected from primary alkyl sulfates, secondary alkane sulfonates, linear alkyl benzene sulfonates, alkyl ether sulfates, furan based anionics, and rhamnolipids.

### Cleaning Boosters

The composition preferably comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers; soil release polymers; alkoxylated polycarboxylic acid esters as described in WO/2019/008036 and WO/2019/007636; and mixtures thereof.

### Antiredeposition Polymers

Preferred antiredeposition polymers include alkoxylated polyamines.

A preferred alkoxylated polyamine comprises an alkoxylated polyethylenimine, and/or alkoxylated polypropylenimine. The polyamine may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25. A preferred material is ethoxylated polyethyleneimine, with an average degree of ethoxylation being from 10 to 30 preferably from 15 to 25, where a nitrogen atom is ethoxylated.

### Soil Release Polymer

Preferably the soil release polymer is a polyester soil release polymer.

Preferred soil release polymers include those described in WO 2014/029479 and WO 2016/005338.

Preferably the polyester based soil release polymer is a polyester according to the following formula (I)

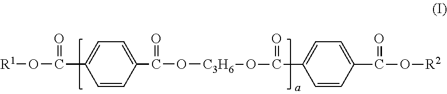

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9.

Preferably the polyester provided as an active blend comprising:
A) from 45 to 55% by weight of the active blend of one or more polyesters according to the following formula (I)

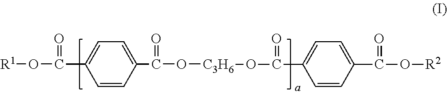

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9 and
B) from 10 to 30% by weight of the active blend of one or more alcohols selected from the group consisting of ethylene glycol, 1,2-propylene glycol, 1,3-propylene glycol, 1,2-butylene glycol, 1,3-butylene glycol, 1,4-butylene glycol and butyl glycol and
C) from 24 to 42% by weight of the active blend of water.

### Alkoxylated Polycarboxylic Acid Esters

Alkoxylated polycarboxylic acid esters are obtainable by first reacting an aromatic polycarboxylic acid containing at least three carboxylic acid units or anhydrides derived therefrom, preferably an aromatic polycarboxylic acid containing three or four carboxylic acid units or anhydrides derived therefrom, more preferably an aromatic polycarboxylic acid containing three carboxylic acid units or anhydrides derived therefrom, even more preferably trimellitic acid or trimellitic acid anhydride, most preferably trimellitic acid anhydride, with an alcohol alkoxylate and in a second step reacting the resulting product with an alcohol or a mixture of alcohols, preferably with C16/C18 alcohol.

### Enzymes

Preferably enzymes, such as lipases, proteases, alpha-amylases, cellulases, peroxidases/oxidases, pectate lyases, and mannanases, or mixtures thereof, may be present in the formulation.

If enzymes are present, then preferably they are selected from: lipases, proteases, alpha-amylases, cellulases and mixtures thereof.

If present, then the level of each enzyme in the laundry composition of the invention is from 0.0001 wt. % to 0.1 wt. %.

Levels of enzyme present in the composition preferably relate to the level of enzyme as pure protein.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422). Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™, Lipex™ and Lipoclean™ (Novozymes A/S).

The invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Protease enzymes hydrolyse bonds within peptides and proteins, in the laundry context this leads to enhanced removal of protein or peptide containing stains. Examples of suitable proteases families include aspartic proteases; cysteine proteases; glutamic proteases; aspargine peptide lyase; serine proteases and threonine proteases. Such protease families are described in the MEROPS peptidase database (http://meros.sanger.ac.uk). Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilisins (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Preferably the subsilisin is derived from Bacillus, preferably Bacillus lentus, B. alkalophilus, B. subtilis, B. amyloliquefaciens, Bacillus pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from Bacillus gibsonii or Bacillus Lentus.

Suitable commercially available protease enzymes include those sold under the trade names names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S).

The invention may use cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™, Endolase™ Renozyme™ (Novozymes A/S), Clazinase™ and Puradax HA™ (Genencor International Inc.), and KAC-500(B)™ (Kao Corporation). Celluclean™ is preferred.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

### Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

### Further Ingredients

The formulation may contain further ingredients.

### Builders or Complexing Agents

The composition may comprise a builder or a complexing agent.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

The composition may also contain 0-10 wt. % of a builder or complexing agent such as ethylenediaminetetraacetic acid, diethylenetriamine-pentaacetic acid, citric acid, alkyl- or alkenylsuccinic acid, nitrilotriacetic acid or the other builders mentioned below.

More preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

If the detergent composition is an aqueous liquid laundry detergent it is preferred that mono propylene glycol or glycerol is present at a level from 1 to 30 wt. %, most preferably 2 to 18 wt. %, to provide the formulation with appropriate, pourable viscosity.

### Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor S N. Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

### Shading Dye

It is advantageous to have shading dye present in the formulation.

Dyes are described in Color Chemistry Synthesis, Properties and Applications of Organic Dyes and Pigments, (H Zollinger, Wiley VCH, Zürich, 2003) and, Industrial Dyes Chemistry, Properties Applications. (K Hunger (ed), Wiley-VCH Weinheim 2003).

Dyes for use in laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹.

Preferred dye chromophores are azo, azine, anthraquinone, phthalocyanine and triphenylmethane. Azo, anthraquinone, phthalocyanine and triphenylmethane dyes preferably carry a net anionic charged or are uncharged. Azine dyes preferably carry a net anionic or cationic charge.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

Shading dyes are discussed in WO 2005/003274, WO 2006/032327 (Unilever), WO 2006/032397 (Unilever), WO 2006/045275 (Unilever), WO 2006/027086 (Unilever), WO 2008/017570 (Unilever), WO 2008/141880 (Unilever), WO 2009/132870 (Unilever), WO 2009/141173 (Unilever), WO 2010/099997 (Unilever), WO 2010/102861 (Unilever), WO 2010/148624 (Unilever), WO 2008/087497 (P&G), WO 2011/011799 (P&G), WO 2012/054820 (P&G), WO 2013/142495 (P&G), WO 2013/151970 (P&G), WO 2018/085311 (P&G) and WO 2019/075149 (P&G).

A mixture of shading dyes may be used.

The shading dye chromophore is most preferably selected from mono-azo, bis-azo and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO2013/142495 and WO2008/087497. A preferred example of a thiophene dye is shown below:

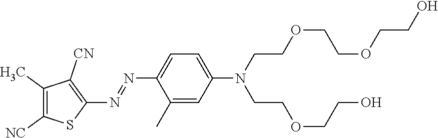 [SMILES: Cc1cc(N(CCOCCO)CCOCCOCCO)ccc1/N=N/c1sc(C#N)c(C)c1C#N]

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, direct violet 66, direct violet 99 and alkoxylated versions thereof.

Alkoxylated bis-azo dyes are discussed in WO2012/054058 and WO/2010/151906. An example of an alkoxylated bis-azo dye is:

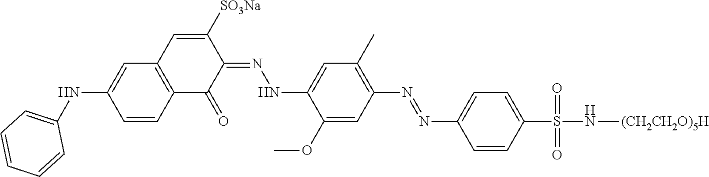

Azine dyes are preferably selected from sulphonated phenazine dyes and cationic phenazine dyes. Preferred examples are acid blue 98, acid violet 50, dye with CAS-No 72749-80-5, acid blue 59, and the phenazine dye selected from:

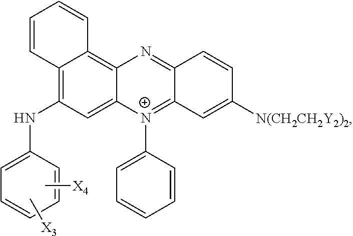

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH)CH₂OH; —OC(O)CH₃; and, C(O)OCH₃.

Anthraquinone dyes covalently bound to ethoxylate or propoxylated polyethylene imine may be used as described in WO2011/047987 and WO 2012/119859.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class. As stated above the shading dye is preferably a blue or violet shading dye.

### Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorq.org/en-us/ingredients #.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low CLog P (ie. those which will have a greater tendency to be partitioned into water), preferably with a CLog P of less than 3.0. These materials, of relatively low boiling point and relatively low CLog P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricyclco decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

It is preferred that the laundry treatment composition does not contain a peroxygen bleach, e.g., sodium percarbonate, sodium perborate, and peracid.

### Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

### Adjunct Ingredients

The detergent compositions optionally include one or more laundry adjunct ingredients.

To prevent oxidation of the formulation an anti-oxidant may be present in the formulation.

The term “adjunct ingredient” includes: perfumes, dispersing agents, stabilizers, pH control agents, metal ion control agents, colorants, brighteners, dyes, odour control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition

The invention will be further described with the following non-limiting examples.

### Examples

### Process to Make the Lignin Derived Surfactant

The lignin derived surfactants of this invention can be prepared as follows.

The first step is to isolate lignin from the lignocellulosic biomass with minimal chemical modification to the lignin biopolymer. This typically requires the use of a lignin-first biorefining process that avoids the formation of undesirable condensation products and also avoids the highly derivatised polymers such as lignosulphonates that are typical with processes used for paper and pulp processing.

Lignin depolymerisation is a complex process with many possible variables. Preferred routes to obtaining lignin polymers that are suitable for further derivatisation according to this invention are those based on solvent methods which preserve the lignin structure. These are described in detail in “Guidelines for performing Lignin First Biorefining” (Abu-Omar et al, Energy and Environmental Science, 2021, vol 14, 262-292). The most preferred extraction route is the dioxasolv process which involves treating lignocellulosic biomass (for example sawdust from Birch) with a mildly acid solution of dioxane. Other biobased solvents such as ethanol and butanol are also suitable.

Next the lignin polymer needs to be selectively depolymerised to maximise the yield of the required monoaromatic species from which the surfactant can then be generated. This was conducted using the process described in “Isolation of Functionalised Phenolic Monomers through selective Oxidation and C-O Bond Cleavage of the β-O-4 Linkages in Lignin” (Lancefield et al, Angew. Chem. Int. Ed., 2015, vol 54, 258-262).

Oxidation of the lignin was then performed using the DDQ catalysed (2, 3-dichloro-5, 6-dicyano-1, 4-benzoquinone) conditions described in Lancefield et al. This was followed by selective degradation of the oxidised β-O-4 structure using a Zinc reductant to give the following monomer structure:-

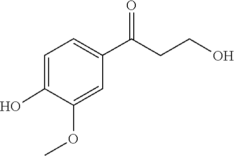

Using this lignin derived aromatic monomer as a starting point, the following reaction scheme highlights the synthetic pathway for a lignin based anionic surfactant whereby R¹=C₁₂ Lauryl. Understanding that the reactants can be substituted by alternatives such that R¹ and R² can vary in length, degree of saturation and degree of branching.

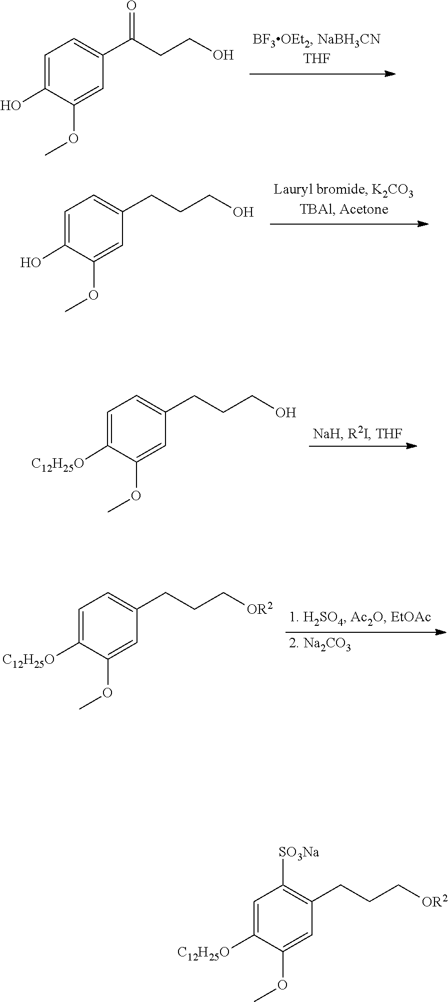

Conversion of the ketone group in the monomer to a methylene group is achieved using a reduction involving a Lewis acid and a reducing agent (in the preferred example the Lewis acid is BF₃·OEt₂ and a hydride reducing agent is used but a wide range of different Lewis acids and reducing agents are known to work for this type of reaction e.g. ZnI₂ combined with Et₃SiH). Alternative methods for carrying out this reaction include the use of H₂ in the presence of a metal catalyst e.g. Pd/C or Ni or the use of the Wolff-Kishner reaction.

Then the R¹ group (in this example Lauryl) is attached via alkylation of the phenolic OH using a suitable alkyl halide in the presence of a base. In this case the alkylating agent is lauryl iodide which is generated in situ from the bromide on reaction with TBAI. A wide range of alternative inorganic bases could be used in this reaction including Na₂CO₃, NaH, LiHMDS, NaHMDS etc. Alternative approaches to derivatisation of the phenolic oxygen include the use of the Mitsonobu reaction. After selective incorporation of the R¹ substituent, the R² group can then be added through alkylation of the primary alcohol. Again, the required alkyl halide and a base (e.g. NaH) are used.

The incorporation of the sulfonate group can be achieved using H₂SO₄ in the presence of an anhydride (for example acetic anhydride). Alternative sulfonation protocols would be expected to achieve an analogous reaction outcome. The initially produced sulfonic acid is then converted to the required sulfonate salt using an inorganic base (for example the use of Na₂CO₃ to generate the sodium sulfonate).

### Materials Used

According to the manufacturing process described above, a variety of lignin derived surfactants were prepared, these are shown hereafter in tabular form (table 1) and selected structures in chemical formula form with their associated internal compound code.

TABLE 1
List of Lignin derived surfactants tested

| | | | | Total No. of |
|---|---|---|---|---|
| | | | No. of | carbon atoms |
| | | | carbon | (including the 3 |
| | | | atoms | carbons from the |
| | R1 | R2 | R1 + R2 | lignin monomer) |
| TM291 | Pentyl | Ethyl | 7 | 10 |
| TM270 | Hexyl | Methyl | 7 | 10 |
| TM339 | 1-Methyl Ethyl | 2-Methyl Propyl | 7 | 10 |
| TM298 | Hexyl | Propyl | 9 | 12 |
| TM285 | Octyl | Methyl | 9 | 12 |
| TM305 | 2-Ethyl Butyl | Propyl | 9 | 12 |
| TM302 | Decanyl | Methyl | 11 | 14 |
| TM327 | Pentyl | 2-Ethyl Butyl | 11 | 14 |
| TM340 | 1-Ethyl Propyl | 2-Ethyl Butyl | 11 | 14 |
| TM307 | Hexyl | Pentyl | 11 | 14 |
| TM294 | Heptyl | Butyl | 11 | 14 |
| TM447 | Octyl | Butyl | 12 | 15 |
| TM248 | Dodecanyl | Methyl | 13 | 16 |
| TM290 | Octyl | Pentyl | 13 | 16 |
| TM449 | Heptyl | 2-Ethyl Butyl | 13 | 16 |
| TM453 | 1-Propyl Butyl | 2-Ethyl Butyl | 13 | 16 |
| TM439 | Octyl | Hexyl | 14 | 17 |

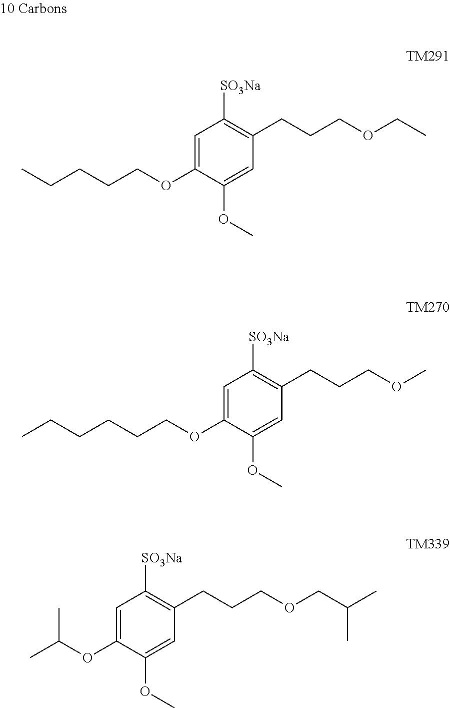

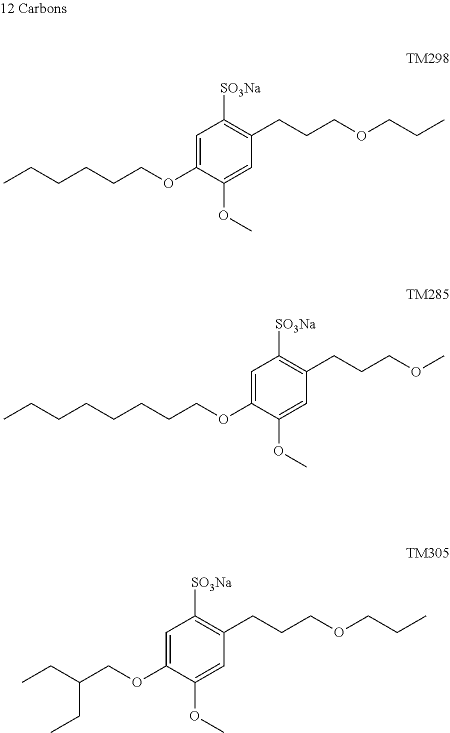

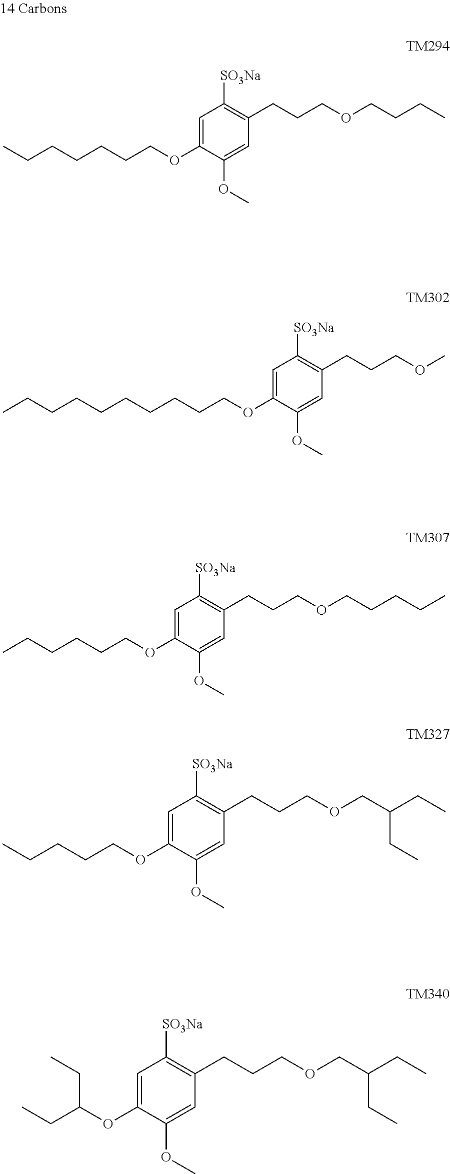

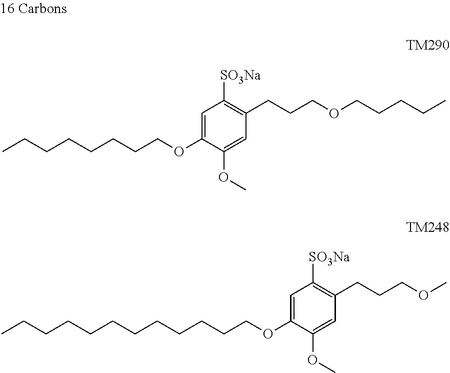

### Example 1—Reduction in Surface Tension for the Lignin Derived Surfactants

The lignin derived surfactants outlined above had their surface tension measured (mN m⁻¹) against concentration (g L⁻¹), which is a good indicator for surfactant performance.

The surface tension measurements were conducted using robotic apparatus from Kibron. The surfactants (both commercial and the lignin derived surfactants of the invention) were all dissolved in a 0.1 M NaCl solution (in de-ionized water) to make 2 g L⁻¹ solutions.

These were then subsequently diluted by a factor of 2 nine times using the 0.1 M NaCl solution (to give concentrations ranging from 2 g L⁻¹ to 0.004 g L⁻¹). This was done using a Hamilton Liquid Handler across a 96 well plate and the surface tension was measured using a Kibron Delta 8 surface tensiometer. Four repeats were carried out for each sample at each concentration and averaged to generate the results given below. Doping the water with NaCl was done for two reasons: i) salts supress the disassociation of individual monomers from micelles (essentially, lowering the CMC) and ii) to keep the water hardness at a constant level.

The results are shown in the following table (table 2). This table clearly show that all the materials have a positive effect on reducing surface tension. However, surfactants TM290, TM248 and TM302 give the lowest surface tension.

TABLE 2
Surface Tension measurements of various lignin derived anionic surfactants

| | 0.004 | 0.008 | 0.016 | 0.03125 | 0.0625 | 0.125 | 0.25 | 0.5 | 1 | 2 |
|---|---|---|---|---|---|---|---|---|---|---|
| | g/L | g/L | g/L | g/L | g/L | g/L | g/L | g/L | g/L | g/L |
| TM291 | 72.0 | 71.9 | 71.3 | 69.8 | 69.0 | 66.9 | 64.0 | 61.3 | 57.2 | 53.0 |
| TM270 | 72.0 | 72.0 | 71.2 | 70.3 | 68.5 | 64.5 | 57.3 | 51.1 | 46.0 | 41.0 |
| TM339 | 72.4 | 72.1 | 71.5 | 70.8 | 69.8 | 68.4 | 66.6 | 64.6 | 62.2 | 59.0 |
| TM298 | 70.0 | 68.3 | 66.0 | 63.0 | 59.5 | 55.7 | 51.4 | 46.8 | 42.5 | 38.1 |
| TM285 | 69.7 | 68.6 | 65.8 | 63.3 | 59.1 | 55.2 | 50.2 | 45.2 | 40.8 | 37.9 |
| TM305 | 69.3 | 67.5 | 64.6 | 60.9 | 56.2 | 51.6 | 47.5 | 43.5 | 39.3 | 36.3 |
| TM302 | 56.5 | 51.3 | 45.4 | 39.8 | 35.4 | 35.5 | 36.4 | 37.3 | 37.1 | 37.8 |
| TM327 | 63.2 | 60.9 | 56.8 | 53.7 | 50.8 | 47.2 | 44.0 | 38.9 | 34.2 | 33.2 |
| TM340 | 66.8 | 64.0 | 61.3 | 58.3 | 55.0 | 51.6 | 47.6 | 44.3 | 41.4 | 38.2 |
| TM307 | 63.8 | 60.4 | 56.4 | 52.9 | 49.5 | 46.4 | 43.0 | 39.5 | 35.5 | 31.7 |
| TM294 | 62.8 | 61.0 | 57.4 | 54.2 | 50.8 | 46.8 | 42.9 | 39.5 | 35.8 | 32.5 |
| TM447 | 72.4 | 71.9 | 71.0 | 68.7 | 63.4 | 56.1 | 48.9 | 42.9 | 36.9 | 31.3 |
| TM248 | 50.9 | 44.6 | 39.2 | 36.8 | 36.0 | 35.9 | 35.7 | 36.0 | 36.0 | 36.1 |
| TM290 | 50.6 | 46.4 | 42.4 | 39.0 | 35.6 | 32.0 | 29.5 | 29.4 | 29.3 | 29.3 |
| TM449 | 69.9 | 70.4 | 67.5 | 62.4 | 56.6 | 51.3 | 45.6 | 40.1 | 34.3 | 30.3 |
| TM453 | 72.0 | 71.8 | 70.4 | 69.1 | 66.1 | 61.6 | 57.1 | 52.4 | 47.0 | 40.3 |
| TN439 | 71.3 | 69.8 | 62.4 | 58.6 | 54.0 | 47.6 | 40.8 | 34.9 | 29.9 | 29.4 |

Various commercial surfactants were also tested in the same way, these are shown in table 3. SAS=Secondary alkane sulfonate, LAS=Linear alkylbenzene sulfonate, SLES=sodium lauryl (3EO) ether sulfate, MES=methyl ester sulfonate and Neodol=C₁₂-C₁₅ alcohol ethoxylate (7EO).

TABLE 3
Surface Tension measurements of various commercial surfactants

| | 0.004 | 0.008 | 0.016 | 0.03125 | 0.0625 | 0.125 | 0.25 | 0.5 | 1 | 2 |
|---|---|---|---|---|---|---|---|---|---|---|
| | g/L | g/L | g/L | g/L | g/L | g/L | g/L | g/L | g/L | g/L |
| SAS | 47.5 | 40.8 | 36.5 | 35.0 | 34.9 | 35.1 | 35.1 | 34.4 | 34.9 | 35.0 |
| LAS | 43.4 | 37.4 | 33.5 | 32.4 | 31.7 | 31.4 | 30.8 | 30.7 | 30.5 | 30.5 |
| SLES | 46.3 | 39.0 | 34.7 | 33.3 | 32.9 | 32.7 | 32.4 | 32.4 | 32.1 | 32.0 |
| MES | 65.3 | 63.3 | 61.2 | 58.9 | 55.8 | 53.2 | 50.1 | 46.8 | 43.5 | 40.7 |
| Neodol | 48.5 | 42.2 | 36.6 | 34.4 | 33.4 | 31.1 | 29.5 | 29.3 | 29.1 | 29.0 |

For surface tension, there are two factors that are important. The first is to reach the critical micelle concentration with the minimum amount of surfactant. The second is the value of the surface tension once the cmc is reached, the lower the better. The tables of results (tables 2 and 3) are very clear in that all the materials are capable of reducing the surface tension to a greater or lesser extent. There are a number of points to highlight however. First, as expected, the total number of carbons is the biggest factor. From table 2, it can be seen that those with R¹+R²=13/14 carbon atoms (corresponding to 16/17 total carbon atoms if including the three carbon atoms from the original lignin monomer) give the best results. This is not usually the case for the commercial surfactants where a linear C12/14 alkyl chain is the predominant feature for good detergency. Equally with LAS, the hydrophobe is always between 10 and 13 carbons in length. Lastly for Neodol nonionics, the alkyl chain is usually C12-C15.

Although both linear and branched carbon chains reduce the surface tension, there is a preference for linear carbon chains as these work better, and good surfactant characteristics were found for those lignin derived anionic surfactant having carbon chains on both sides of the ring (R1 and R2 having carbon chains).

### Example 2—CMC/Surface Tension Measured for Selected Lignin Derived Surfactants Against Commercial Surfactants

For three selected lignin derived surfactants (TM 248, TM 290 and TM 302), measurements were taken-using a Kruss K100 tensiometer with a Wilhemy Plate probe. We also compared them against known high performing commercial materials that are in everyday use (LAS=Linear Alkyl Benzene Sulphonate, SAS=Secondary Alkane Sulphonate, SLES=Sodium Lauryl Ether Sulphate 3EO). The CMC and surface tension values (table 4) show that the selected lignin derived surfactants compare well with the measured commercial surfactants.

TABLE 4
CMC Results

| | CMC | Surface Tension |
|---|---|---|
| Material | (g/L) | at the cmc |
| LAS | 0.0315 | 30.8 |
| SAS | 0.0342 | 28.5 |
| SLES 3EO | 0.0331 | 28.5 |
| TM302 | 0.0962 | 33.3 |
| TM248 | 0.0268 | 33.5 |
| TM290 | 0.0282 | 26.7 |

### Example 3—Interfacial Tension Measurements

Interfacial tension measurements were taken for mixtures of the new surfactants with a standard nonionic ethoxylate material (3:1 mix of anionic lignin derived surfactant: nonionic Neodol 25-7 alcohol ethoxyate).

Interfacial tension was measured using a Kruss DVT50 Tensiometer. In this method, an oil (in this case olive oil) is pumped through a narrow orifice at a controlled rate into the bottom of a glass sample cell holding a solution of the test surfactant. The size of the oil droplets as they detach from the needle and rise to the surface due to density differences can then be used to calculate the dynamic interfacial tension between the oil droplet and the surfactant solution. The size of the droplets is then calculated from the flow rate of the oil and the frequency of the detachment (as detected by a light sensor on the side of the glass cell).

The anionic surfactants (both commercial and the lignin derived surfactants of the invention) were mixed in a ratio of 3:1 by weight with a standard commercial nonionic (Neodol 25-7 ex Shell which is a C12-15 alcohol ethoxylate which has an average of 7EO groups). The nonionic was introduced to make sure that the anionics did not suffer from calcium precipitation effects in the moderately hard 26° FH water that was used. Total surfactant concentration was always kept constant at 1 g/L and the water hardness was fixed at 26° FH.

Interfacial tension measurements were taken at a flow rate of 1 microlitres per min. A minimum of three measurements was made at the flow rate (up to a maximum of five) to ensure the standard deviation of the measurement was reduced for accuracy. The results are shown in Table 5.

TABLE 5
Interfacial tension measurements
for lignan derived surfactants

| | IFT (at flow |
|---|---|
| | rate 1 uL/min) |
| TM291 | 3.495535 |
| TM270 | 4.816827 |
| TM339 | 6.514892 |
| TM298 | 3.013843 |
| TM285 | 2.952449 |
| TM305 | 3.730944 |
| TM302 | 0.925284 |
| TM327 | 3.284271 |
| TM340 | 2.702683 |
| TM307 | 2.445171 |
| TM294 | 1.775611 |
| TM248 | 0.413589 |
| TM290 | 0.606773 |

Again, all of the lignin derived materials performed well. The results of these materials were comparable to the commercial materials (LAS, SLES and SAS) and were an improvement over MES. This is especially seen with the stand-out results being from materials TM294, TM302, TM290 and TM248.

To put the data in table 5 in context, comparison can be made with the results in table 6, where the same test was carried out with commercial anionic surfactants (LAS, SAS, SLES-3EO and MES [methyl ester sulfonate]). The comparison between tables 5 and 6 shows that for many of the tested lignin derived surfactants in table 5 they compared well against the commercial materials LAS, SAS and SLES-3EO, as well as many materials outperforming a different commercial surfactant MES.

TABLE 6
Interfacial tension measurements
for commercial surfactants

| | IFT (at flow |
|---|---|
| | rate 1 uL/min) |
| LAS | 0.267 |
| SAS | 0.401 |
| SLES | 0.430 |
| MES | 1.63 |

The examples show that the lignin derived anionic surfactants perform well as surfactants (as measured by CMC and surface tension) and compare well against commercial surfactants both in surfactant characteristics (examples 1-3). This is especially important as the claimed materials are greener surfactants made from waste materials.

A final advantage of these materials as claimed is that it gives the ability to use two shorter linear chains rather than one long single chain. We can get higher carbon numbers into molecule (which is good for surfactancy as shown in our surface tension results) without the molecule becoming insoluble (which can be problem with long linear chains). Having long linear alkyl chains is believed to be detrimental in terms of aquatic toxicity, so this approach of splitting the hydrocarbon and having a pseudo branched (or V shaped) architecture allows you to increase carbon chain number without having linear C16/17 chains. Another advantage is that having this pseudo branched/V shaped architecture with high C number is good for low temp fat cleaning.

The invention claimed is:

1. A detergent composition, comprising:
a) from 0.5 to 40 wt. % of a lignin derived anionic surfactant,
wherein the lignin derived anionic surfactant has the following structure (1) or (2): 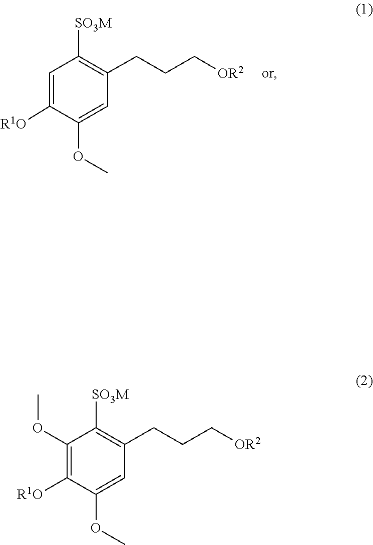
wherein: M is a counterion, selected from Na, K, and NH₄;
R¹ and R² are alkyl or alkenyl groups, each either linear or branched; and
the alkyl or alkyenyl groups R¹ and R² added together contain from 5 to 15 carbon atoms, with the proviso that R¹ and R² each contain at least 1 carbon atom.

2. The detergent composition according to claim 1, wherein the alkyl or alkenyl groups R¹ and R² are linear.

3. The detergent composition according to claim 1, wherein R¹ has from 5 to 14 carbon atoms.

4. The detergent composition according to claim 1, wherein R² has from 1 to 8 carbon atoms.

5. The detergent composition according to claim 1, wherein R¹ has from 8 to 12 carbon atoms, and R² has from 1 to 5 carbon atoms.

6. The detergent composition according to claim 1, wherein the alkyl groups R¹ and R² added together contain from 9 to 15 carbon atoms.

7. The detergent composition according to claim 1, additionally comprising from 1 to 40 wt. % of one or more nonionic surfactants, wherein the nonionic surfactant is selected from alcohol alkoxylates; alkyl polyglucosides; alkyl polypentosides; and, nonionic biosurfactants.

8. The detergent composition according to claim 1, wherein the composition additionally comprises from 1 to 40 wt. % of one or more additional anionic surfactants other than the lignin based anionic surfactant, wherein the additional anionic surfactant is selected from primary alkyl sulfates, secondary alkane sulfonates, linear alkyl benzene sulfonates, alkyl ether sulfates, internal olefin sulfonates, alpha olefin sulfonates, soaps, anionically modified APGs, furan based anionics, anionic biosurfactants (e.g. rhamnolipids), and, citrems, tatems and datems.

9. The detergent composition according to claim 1, wherein the composition comprises from 0.5 to 15 wt. % of cleaning boosters selected from antiredeposition polymers, soil release polymers, alkoxylated polycarboxylic acid esters and mixtures thereof.

10. The detergent composition according to claim 9, wherein the antiredeposition polymers are alkoxylated polyamines; and/or the soil release polymer is a polyester soil release polymer.

11. The detergent composition according claim 1, wherein the composition is a laundry detergent composition.

12. The detergent composition according to claim 1, wherein the composition comprises one or more enzymes selected from lipases, proteases, alpha-amylases, cellulases, peroxidases/oxidases, pectate lyases, and mannanases, or mixtures thereof, wherein the level of each enzyme in the composition of the invention is from 0.0001 wt. % to 0.1 wt. %.

13. A method of treating a textile, the method comprising the step of: treating the textile with an aqueous solution of 0.5 to 20 g/L of the detergent composition of claim 1, and optionally drying the textile.

14. The method according to claim 13, wherein the method occurs at wash water temperatures of 280 to 335K.

15. The detergent composition according to claim 1, wherein each of R¹ and R² are alkyl groups.

16. The detergent composition according to claim 1, wherein R¹ has from 5 to 12 carbon atoms.

17. The detergent composition according to claim 1, wherein R¹ has from 8 to 12 carbon atoms.

18. The detergent composition according to claim 1, wherein R² has from 1 to 7 carbon atoms.

19. The detergent composition according to claim 1, wherein R² has from 1 to 5 carbon atoms.

20. The detergent composition according to claim 1, wherein the alkyl groups R¹ and R² added together contain from 11 to 15 carbon atoms.
